(19) United States
(12) Patent Application Publication
(10) Pub. No.: US 2019/0062602 A1
(43) Pub. Date: Feb. 28, 2019

(54) IMPROVED PRESSURE SENSITIVE ADHESIVE COMPOSITIONS

(71) Applicant: 3M INNOVATIVE PROPERTIES COMPANY, St. Paul, MN (US)

(72) Inventors: Prince P. Antony, London, Ontario (CA); Joseph T. Bartusiak, Osseo, MN (US); Christopher J. Rother, Hudson, WI (US); Bradley S. Forney, Cottage Grove, MN (US); Justin M. Bolton, Minneapolis, MN (US); Nishant C. Kumar, Woodbury, MN (US); Shaun M. West, Saint Paul, MN (US); Dean Xiong, London, Ontario (CA)

(21) Appl. No.: 16/074,691

(22) PCT Filed: Jan. 26, 2017
(86) PCT No.: PCT/US2017/015163

§ 371 Date: Aug. 1, 2018

Related U.S. Application Data
(60) Provisional application No. 62/289,673, filed on Feb. 1, 2016.

(51) Int. Cl. C09J 7/38; C09J 11/08; C09J 7/21; C09J 7/22

(52) U.S. Cl. CPC C09J 7/387; C09J 11/08; C09J 7/21; C09J 7/22; C09J 2400/283; C09J 2409/00; C09J 2453/00; C09J 2205/114; C09J 2205/102; C09J 2461/00

(57) ABSTRACT

The present disclosure generally relates to adhesive compositions, adhesive articles including the adhesive compositions, methods of making the adhesive compositions and articles, and methods of using the adhesive compositions and articles. The adhesive compositions of the present disclosure include a thermoplastic phenolic resin made from the reaction of (1) alkyl phenol (e.g., butyl- or octyl- or -nonyl) and formaldehyde; or (2) alkyl phenol (e.g., butyl- or octyl-) and acetaldehyde; or (3) alkyl phenol (e.g., butyl- or octyl-) and acetylene. The present disclosure also generally relates to adhesive articles including these adhesive compositions. The inventors of the present disclosure found that such adhesive articles exhibit excellent adhesion to architectural coatings with including low or no VOCs, deep base formulations, and/or formulations including primer in various conditions, including, for example, high humidity.

### TECHNICAL FIELD

The present disclosure generally relates to adhesive compositions, adhesive articles including the adhesive compositions, methods of making the adhesive compositions and articles, and methods of using the adhesive compositions and articles.

### BACKGROUND

Command® Adhesive Strip products are a line of adhesive strips that holds strongly on a variety of surfaces (including paint, woods, and tile) and that remove cleanly—no holes, marks, or sticky residue. In general, these products include an adhesive composition disposed on a tape or other backing. These products generally have utility in bonding to various surfaces or substrates for numerous applications. These adhesive products are designed to firmly adhere an article, such as a hook (to hold a picture or an article of clothing) or other decorative or utilitarian element, to a surface (an adherend), yet remove cleanly when pulled away from the architectural surface at a low angle. The clean removal aspect is so that a tacky and/or unsightly residue is not left behind on the surface after removal of the adhesive article.

Additionally, various types of masking or other tape can be applied to adherends. Such tapes are typically used to mask off areas of a wall or architectural surface that should not be painted. The tape includes a backing coated with a pressure sensitive adhesive. The pressure sensitive adhesive permits easy removal of the masking tape without damage to the adherend. The strength of the adhesive used on the tape can be varied depending on the intended use.

One exemplary adherend to which masking tapes and Command® Adhesive strip products are routinely applied is a wall coated with an architectural coating (e.g, paint, varnish, stain, etc). The formulation of many architectural coatings have changed in recent years including, in some cases, to reduce or eliminate volatile organic compounds (VOCs) and make the architectural coatings deliverable via a water-based vehicle. Such formulations typically contain higher amounts of non-volatile compatibility enhancing compounds such as surfactants and polymers that can associate with both the pigment and the water phase to maintain the dispersion stability of the formulation, aid in coalescence during drying, or both. In addition, recent fashion trends in architectural coatings have shifted toward more saturated color palettes, which in turn require higher pigment content and thus more dispersion stabilizers as part of the formulations. An example of this includes deep base paints formulated for more saturated colors. Also, modern architectural coatings have changed, in some cases, to accommodate formulations wherein the need for a separate primer layer is eliminated such as in the case of paint and primer-in-one coatings (or “combination paint/primers”).

As a result of these recent formulation changes, painted surfaces have been found to be a highly complex, variable and dynamic mixture of components. Surfactants, dispersants, or other additives have in some cases been found to be mobile within the solidified coating and may “bloom” to the air-coating interface. In addition, at elevated relative humidity, surface polarity of many architectural coatings has been observed to both increase and become more heterogeneous. While not intending to be bound by theory, it is believed that this increase in polarity and heterogeneity is attributable to water sorption and concomitant dispersant/additive migration. These changes can be exacerbated in coatings having increased concentrations of mobile surfactants and other hydrophilic and amphiphilic compounds.

### SUMMARY

The inventors of the present disclosure sought to improve the adhesive that can be used on architectural coatings, including, for example, those including low or no VOCs, deep base formulations, formulations including primer, scrubbable paints, etc. The inventors of the present disclosure also sought to create masking tapes and adhesive articles that can be used on architectural coatings, including, for example, those including low or no VOCs, deep base formulations, formulations including primer, etc.

The inventors of the present disclosure discovered that, in some embodiments, inclusion of a thermoplastic phenolic resin made from the reaction of (1) alkyl phenol (e.g., butyl- or octyl-) and formaldehyde; or (2) alkyl phenol (e.g., butyl- or octyl-) and acetaldehyde; or (3) alkyl phenol (e.g., butyl- or octyl- or -nonyl) and acetylene in the adhesive resulted in an adhesive composition with excellent adhesion to architectural coatings—even at high humidity—with low or no VOCs, deep base formulations, formulations including primer, etc. In some embodiments, the thermoplastic phenolic resin is a novolac resin. Generally, novolac resins are phenol-formaldehyde resins. Some embodiments have a formaldehyde to phenol molar ratio of less than one. In some embodiments, the polymerization is brought to completion using acid-catalysis such as oxalic acid, hydrochloric acid or sulfonate acids. In some embodiments, the phenol units are linked by methylene and/or ether groups.

In some embodiments, a pressure sensitive adhesive composition comprises a thermoplastic phenolic resin made from the reaction of (1) alkyl phenol (e.g., butyl- or octyl- or -nonyl) and formaldehyde; or (2) alkyl phenol (e.g., butyl- or octyl-) and acetaldehyde; or (3) alkyl phenol (e.g., butyl- or octyl-) and acetylene.

In some embodiments, a pressure sensitive adhesive comprises at least one of an acrylic, a rubber, a natural rubber, an isoprene block copolymer, a butadiene block copolymer, and combinations thereof.

In some embodiments, the isoprene block copolymer is styrene-isoprene-styrene block copolymer.

In some embodiments, the butadiene block copolymer is styrene-butadiene-styrene block copolymer.

Some embodiments comprise a tackifier selected from a list consisting essentially of polyterpene, rosin esters, terpene phenol, a hydrocarbon resin, and combinations thereof.

In some embodiments, the thermoplastic phenolic resin is present in an amount of between about 2 wt % and about 45 wt %.

In some embodiments, the alkyl phenol has been modified with a functional group selected from a list consisting essentially of epoxy, rosin, terpene, butadiene, and combinations thereof.

In some embodiments, an adhesive articles comprises a backing and a pressure sensitive adhesive composition

In some embodiments, the backing is paper or plastic.

In some embodiments, the adhesive article exhibits improved adhesion to an adherend including an architectural coating having at least one of low or no VOCs, a deep base formulation, or a formulation including primer as compared to an adhesive article not including the thermoplastic phenolic resin.

In some embodiments, the adhesive article exhibits improved adhesion to an adherend including an architectural coating having at least one of low or no VOCs, a deep base formulation, or a formulation including primer as compared to an adhesive article not including the thermoplastic phenolic resin when measured at 79° F. and 74% relative humidity.

In some embodiments, the adherend is at least one of painted drywall, glass, stainless steel, plastic, or combinations thereof.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

The present disclosure generally relates to adhesive compositions including a thermoplastic phenolic resin made from the reaction of (1) alkyl phenol (e.g., butyl- or octyl-) and formaldehyde; or (2) alkyl phenol (e.g., butyl- or octyl-) and acetaldehyde; or (3) alkyl phenol (e.g., butyl- or octyl-) and acetylene. In some embodiments, the thermoplastic phenolic resin is a novolac resin. The present disclosure also generally relates to adhesive articles including this adhesive composition. The inventors of the present disclosure found that such adhesive articles exhibit excellent adhesion to architectural coatings with including low or no VOCs, deep base formulations, and/or formulations including primer in various conditions, including, for example, high humidity.

Adhesive Composition

Adhesive compositions of the present disclosure include a thermoplastic phenolic resin made from the reaction of (1) alkyl phenol (e.g., butyl- or octyl- or -nonyl) and formaldehyde; or (2) alkyl phenol (e.g., butyl- or octyl-) and acetaldehyde; or (3) alkyl phenol (e.g., butyl- or octyl-) and acetylene. An acidic catalyst and a molar excess of phenol are the conditions used to make novolac resins. The phenol units are mainly linked by methylene and/or ether groups.

In some embodiments, the thermoplastic phenolic resin is a novolac resin. Generally, novolac resins are phenol-formaldehyde resins. Some embodiments have a formaldehyde to phenol molar ratio of less than one. In some embodiments, the polymerization is brought to completion using acid-catalysis such as oxalic acid, hydrochloric acid or sulfonate acids. In some embodiments, the phenol units are linked by methylene and/or ether groups.

The thermoplastic phenolic resin can be present in an amount of between about 2 wt % and about 45 wt %. In some embodiments, the thermoplastic resin is present in an amount of at least 2 wt %, at least 5 wt %, at least 8 wt %, at least 10 wt %, at least 12 wt %, at least 15 wt %, at least 18 wt %, at least 20 wt %, at least 22 wt %, at least 25 wt %, at least 28 wt %, at least 30 wt %, at least 32 wt %, at least 35 wt %, at least 38 wt %, or at least 40 wt %. In some embodiments, the thermoplastic phenolic resin is present in an amount of less than 45 wt %, less than 42 wt %, less than 40 wt %, less than 38 wt %, less than 35 wt %, less than 33 wt %, less than 30 wt %, less than 28 wt %, less than 25 wt %, less than 22 wt %, less than 20 wt %, less than 18 wt %, less than 15 wt %, less than 12 wt %, or less than 10 wt %.

In some embodiments, the adhesive composition further includes at least one of natural rubber, synthetic rubber, SIS, SBS, SEBS, acrylate, polyurethane, silicone, silicone block copolymer, polyisoprene rubber, EPDM, buty rubber, and combinations thereof.

In some embodiments, the adhesive includes a tackifier. Some exemplary tackifiers include terpene phenol, polyterpene, rosin esters, hydrovardbon resins like C5 or C9, and combinations thereof.

In some embodiments of the present disclosure, the adhesive composition is a pressure sensitive adhesive. A general description of useful pressure-sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964).

In some embodiments, adhesion properties of the adhesive can range from 0 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

Adhesive Articles

The peelable adhesive can include any peelable adhesive having the desired properties.

In some embodiments, the peelable adhesive is a pressure sensitive adhesive. A general description of useful pressure-sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure-sensitive adhesive. Exemplary pressure-sensitive adhesives utilize one or more thermoplastic elastomers, e.g. in combination with one or more tackifying resins.

In some embodiments, the peelable adhesive layer can include at least one of rubber, silicone, or acrylic based adhesives. In some embodiments, the peelable adhesive layer can include a pressure-sensitive adhesive (PSA) or an epoxy adhesive. In some embodiments, the peelable adhesive can include tackified rubber adhesives, such as natural rubber; olefins; silicones, such as silicone polyureas; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above. The adhesive can be, for example, any of the adhesives described in any of the following patent applications, all of which are incorporated by reference herein: PCT Patent Publication Nos. 2015/035556, 2015/035960, and US 2015/034104.

In some embodiments, the adhesive includes a tackifier. Some exemplary tackifiers include at least one of polyterpene, terpene phenol, rosin esters, and/or rosin acids.

In some embodiments, the peelable adhesive is a flowable adhesive that can be coated onto the backing. In some embodiments, the peelable adhesive is a more solid adhesive as is generally described in, for example, German Patent No. 33 31 016.

In some embodiments, adhesion properties of the adhesive can range from 0 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

In some embodiments, the peelable adhesive can provide a shear force of, for example, 4-20 pounds per square inch.

In some embodiments, the adhesive article can be peeled from at least one of the second terminal end, the first side, or the second side. In some embodiments, the adhesive article can be peeled from at least two of the second terminal end, the first side, or the second side.

In some embodiments, the peelable adhesives are tailored to achieve peel with no or minimal damage. Exemplary methods and articles for doing so are described in, for example, U.S. Pat. No. 6,835,452 and patent applications filed by the present assignee under the following matter numbers: 77329US002, 77513US002, and 77514US002.

In some embodiments, the adhesive articles of the present disclosure can be removed from a substrate or surface without causing damage. As used herein, the term “without causing damage” or “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

Some adhesive articles that can include the adhesive composition described herein include a backing having opposed first and second major surfaces. The adhesive composition is coated on at least a portion of one or both of the first and/or second major surface of the backing. In some embodiments, the thickness of the adhesive on at least one of the first or second major surfaces of the backing is about 1 μm to about 1 mm.

The backing can be made of any desired material. Useful backings include, e.g., a polymeric foam layer, a polymeric film layer, and combinations thereof.

Specific stretch releasable adhesive strips suitable for use in the various embodiments of the present invention include the pressure sensitive adhesives with elastic backings described in U.S. Pat. No. 4,024,312 (Korpman), the pressure sensitive adhesives with highly extensible and substantially inelastic backings described in U.S. Pat. No. 5,516,581 (Kreckel et al.), and PCT Application No. WO 95/06691, and Bries et al. (U.S. Pat. No. 6,231,962), and the solid, elastic pressure sensitive adhesive described in German Patent No. 33 31 016, all of which are incorporated by reference herein in their entirety.

Representative examples of suitable polymeric backing materials for polymeric foam layers or solid polymeric film layers include polyolefins, e.g., polyethylene, including high density polyethylene, low density polyethylene, linear low density polyethylene, and linear ultra low density polyethylene, polypropylene and polybutylenes; vinyl copolymers, e.g., polyvinyl chlorides, both plasticized and unplasticized, and polyvinyl acetates; olefin copolymers, e.g., ethylene/methacrylate copolymers, ethylene/vinylacetate copolymers, acrylonitrile-butadiene-styrene copolymers, and ethylene/propylene copolymers; acrylic polymers and copolymer; and combinations thereof. Mixtures or blends of any plastic or plastic and elastomer materials, such as polypropylene/polyethylene, polyurethane/polyolefin, polyurethane/polycarbonate, and polyurethane/polyester, can also be used. Solid polymeric film backings are preferably selected from polyethylene and polypropylene films, with the most preferred materials being unoriented linear low density and ultra low density polyethylene films. An example of a useful linear low density polyethylene film is commercially available under the trade designation XMAX 161.1 from Huntsman Packaging (Chippewa Falls, Wis.).

Polymeric foams can be selected to optimize tape properties such as conformability and resiliency, which are useful when the tape is to be adhered to surfaces having surface irregularities, e.g., painted wallboard. Conformable and resilient polymeric foams are well suited for applications in which the adhesive tape is to be adhered to surfaces having surface irregularities. Such is the case with a typical wall surface. Polymeric foam layers for use in the backing generally will have a density of about 2 to about 30 pounds per cubic foot (about 32 to about 481 kg/m.sup.3), particularly in tape constructions where the foam is to be stretched to effect debonding.

Polyolefin foams are preferred plastic polymeric foam layers for the tape backing. Polymeric foam layers are most preferably polyolefin foams available under the trade designations Volextra™ and Volara™ from Voltek, Division of Sekisui America Corporation (Lawrence, Mass.).

Where only one polymeric film or foam layer of a multi-layer backing is intended to be stretched to effect debonding, that layer should exhibit sufficient physical properties and be of a sufficient thickness to achieve that objective.

Polymeric films may be used to increase load bearing strength and rupture strength of the tape. Films are particularly well suited to applications involving adhering smooth surfaces together. A polymeric film layer preferably has a thickness of about 0.4 to about 10 mils, more preferably from about 0.4 to about 6 mils.

The backing can include an elastomeric material. Suitable elastomeric backing materials include, e.g., styrene-butadiene copolymer, polychloroprene (i.e., neoprene), nitrile rubber, butyl rubber, polysufide rubber, cis-1,4-polyisoprene, ethylene-propylene terpolymers (e.g., EPDM rubber), silicone rubber, silicone polyurea block copolymers, polyurethane rubber, polyisobutylene, natural rubber, acrylate rubber, thermoplastic rubbers, e.g., styrene-butadiene block copolymers and styrene-isoprene-styrene block copolymers, and thermoplastic polyolefin rubber materials.

The stretch releasing pressure sensitive adhesive tape can be constructed in a variety of configurations. For example, the tape can include a backing having several distinct layers arranged in a stack and can include alternating layers of elastic, plastic (e.g., polymeric film), foam or adhesive materials and combinations thereof. The backing layers can be bonded to one another according to a variety of methods including, e.g., adhesive, laminating or coextrusion. The stretch releasing pressure sensitive adhesive tape can be single-coated (i.e., at least one pressure-sensitive adhesive composition is disposed on one surface of the backing) or double-coated (i.e., two opposite surfaces of the backing include an adhesive composition). The pressure-sensitive adhesive tape can include a number of different adhesive compositions, a number of layers of the same or different adhesive composition, and combinations thereof, disposed on a single surface of a backing or on multiple surfaces of a backing.

Examples of useful tape and backing constructions are described in U.S. Pat. No. 4,024,312 (Korpman), U.S. Pat. No. 5,516,581 (Kreckel et al.), U.S. Pat. No. 6,001,471 (Bries et al.) and U.S. Pat. No. 6,004,642 (Langford) and PCT International Publication WO 95/06691 and incorporated herein. Other examples of useful tape and backing constructions include splittable layer backings as described in PCT International Publication WO 98/21285 and re-fastenable layer backings as described in PCT International Publication WO 99/31193, all of which are incorporated herein.

The stretch releasing pressure sensitive adhesive tape can include a non-tacky tab, e.g., as illustrated in the Figures, which can be grasped and pulled by a user to stretch the tape during the removal process, so as to remove the tape from the object or substrate to which it has been affixed. The non-tacky tab can be an extension of the backing material or a detackified portion of the stretch releasing pressure sensitive adhesive. The non-tacky tab can be formed from a tacky adhesive substrate using any known method of producing a non-tacky area including, e.g., applying a detackifying material to the adhesive to render it non-tacky.

The stretch releasing pressure sensitive adhesive tape can also include one or more liners disposed on the exposed surface(s) of the pressure sensitive adhesive composition to protect the adhesive until use. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone polycoated paper. The release liners can be printed with lines, brand indicia, or other information.

Some embodiments further include a mounting device. Exemplary mounting devices include, for example, hooks, clips, and loops. Any of the following mounting devices can be used with the adhesive article of the present disclosure: Application Matter No. 77486US002 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.), all of which are incorporated by reference in their entirety herein.

Some adhesive articles of the present disclosure have excellent shear strength. Some embodiments of the present disclosure have a shear strength of greater than 1800 minutes as measured according to ASTM D3654. Some embodiments of the present disclosure have shear strength of greater than 10,000 minutes as measured according to ASTM D3654.

In some embodiments, the adhesive article has a thickness that is between about 0.1 mil and about 10 mils. In some embodiments, the thickness is greater than 0.1 mil, greater than 1 mil, greater than 2 mils, greater than 3 mils, greater than 4 mils, greater than 5 mils, greater than 6 mils, or greater than 7 mils. In some embodiments, the thickness is less than 10 mils, less than 9 mils, less than 8 mils, less than 7 mils, less than 6 mils, less than 5 mils, less than 4 mils, less than 3 mils, or less than 2 mils.

In some embodiments, the peel force is below 30 oz/inch at all points along the adhesive article.

Some adhesive articles of the present disclosure exhibit improved adhesion to an adherend including an architectural coating having at least one of low or no VOCs, a deep base formulation, or a formulation including primer as compared to an adhesive article not including the thermoplastic phenolic resin. Some adhesive articles of the present disclosure exhibit improved adhesion to an adherend including an architectural coating having at least one of low or no VOCs, a deep base formulation, scrubbable paints, or a formulation including primer as compared to an adhesive article not including the thermoplastic phenolic resin under high humidity conditions. In some embodiments, high humidity conditions have a temperature of 79° C. and a relative humidity of 74%.

In some embodiments, the adherend is at least one of painted drywall, glass, stainless steel, polyethylene, drywall, plastic, polypropylene, polystyrene, painted wood, painted drywall, painted faux wood trim, and combinations thereof.

Methods of Use

The adhesive articles of the present disclosure can be used in various ways. In some embodiments, the backing is applied, attached to, or pressed into an adherend. In this way, the backing contacts the adherend. Where a release liner is present, the release liner is removed before the backing is applied, attached to, or pressed into the adherend. In some embodiments, at least a portion of the adherend is wiped with alcohol before the backing is applied, attached to, or pressed onto the adherend.

In some embodiments, to remove the backing and/or adhesive article from the adherend, at least a portion of the backing and/or adhesive article is peeled from the adherend. In embodiments where a tab is present, the user can grip the tab and use it to peel the backing from the adherend.

In some embodiments, to remove the backing and/or adhesive article from the adherend, at least a portion of the backing and/or adhesive article is stretch released from the adherend. In embodiments where a tab is present, the user can grip the tab and use it to stretch release the backing from the adherend.

Methods of Making

Various methods can be used to make the adhesive compositions of the present disclosure. One exemplary method is as follows. A packaging material that is used to form the reaction vessel or container is preferably made of a material that when combined with the adhesive composition does not substantially adversely affect the desired adhesive characteristics. A hot melt coated adhesive produced from a mixture of the adhesive composition and the packaging material may have improved adhesive properties compared to a hot melt coated adhesive produced from the adhesive composition alone.

In one embodiment of the disclosure, the reaction mixture is substantially surrounded with the packaging material; in another embodiment of the disclosure; the reaction mixture is completely surrounded with the packaging material. In this embodiment, it is intended that the reaction mixture be completely surrounded by the packaging material, but random variations in production may produce occasional packaged pre-adhesives in which the reaction mixture is not completely surrounded with the packaging material. In yet other embodiments, the reaction mixture is disposed between a pair of sheets.

At least one component of the packaging material (more preferably the entirety of the packaging material) preferably melts at or below the processing temperature of the adhesive (i.e., the glass transition temperature Tg, at which the adhesive composition begins to flow). The packaging material preferably has a melting point of 200° C. or less, preferably 170° C. or less. In a preferred embodiment the melting point ranges from 90° C. to 150° C.

The packaging material may be a flexible thermoplastic polymeric film, more preferably an unsupported, non-laminate thermoplastic polymer film. The packaging material is preferably selected from ethylene-acrylic acid, ethylene-vinyl acetate, polypropylene, polyethylene, polybutadiene, or ionomeric films. In a presently preferred embodiment, the packaging material is an ethylene-acrylic acid or ethylene-vinyl acetate film. Particularly suitable polymeric films include heat sealable linear low density polyethylene (LLDPE) films produced by 3M Company (St. Paul, Minn.).

In practicing some embodiments of the present disclosure, films ranging in thickness from about 0.01 mm to about 0.25 mm may be used. The thicknesses preferably range from about 0.025 mm to about 0.127 mm to obtain films that have good strength during processing while being thin enough to heat seal quickly and minimize the amount of film material used.

The amount of packaging material depends upon the type of material and the desired end properties. The amount of packaging material typically ranges from about 0.5 percent to about 20 percent of the total weight of the reaction mixture and the packaging material. Preferably, the packaging material is between 2 percent and 15 percent by weight, and more preferably between 3 percent and 5 percent.

Suitable packaging materials may contain plasticizers, stabilizers, dyes, perfumes, fillers, slip agents, antiblock agents, flame retardants, anti-static agents, microwave susceptors, thermally conductive particles, electrically conductive particles, and/or other materials to increase the flexibility, handleability, visibility, or other useful property of the film, as long as they do not adversely affect the desired properties of the adhesive.

The packaging material should be appropriate for the polymerization method used. For example, with photopolymerization, it is necessary to use a film material that is sufficiently transparent to ultraviolet radiation at the wavelengths necessary to effect polymerization.

The present disclosure also provides methods for making packaged viscoelastic adhesive compositions in which the packaging material is either retained following polymerization (and thus becomes part of the final product), i.e. a “Type I Composition”, or is removed following polymerization and prior to subsequent processing, i.e. a “Type II Composition”. The two types of compositions will be discussed separately further below. The description of the two types of products will be made with particular reference to hot melt adhesive compositions. However, the principles described below are equally applicable to other types of viscoelastic compositions, including pressure sensitive adhesives, adhesives generally, hot melt processable sealants, vibration damping materials, and viscoelastic gels useful for medical applications.

The present disclosure provides a method of making a packaged, thermoplastic or thermosettable, hot melt adhesive composition. For Type I compositions, the packaging material is selected such that it does not substantially adversely affect the desired adhesive properties of the hot melt adhesive composition when the hot melt adhesive composition and the packaging material are heated above the melting temperature of at least one component of the packaging material, and mixed together to form a flowable, coatable melt.

The disclosure also provides a method of making two or more packages of a packaged, thermoplastic or thermosettable hot melt adhesive. In this method, two or more portions of a reaction mixture are provided and each of the portions is completely surrounded with a packaging material. These portions are then (co)polymerized as described above.

In one preferred embodiment, the reaction mixture is completely surrounded by the packaging material. Preferably, from 0.1 to 5,000 g of reaction mixture is completely surrounded by the packaging material. In another preferred embodiment, from 1 to 1,000 g of reaction mixture is completely surrounded by the packaging material.

In yet another embodiment of the disclosure, the reaction mixture is substantially surrounded by the packaging material. In a further embodiment, the reaction mixture is disposed between a pair of two substantially parallel sheets of packaging material.

In the Type II compositions, the packaging material is removed after polymerization so that any further processing, e.g., melting, coating, or simply application of the adhesive, involves only the adhesive. The adhesive and reaction mixtures described above in the case of the Type I compositions are equally suitable for the Type II compositions, as are the polymerization processes and conditions used to prepare the adhesive.

The packaging materials described in connection with the Type I compositions are also suitable. However, because the packaging material is removed before any post-polymerization processing, the choice of packaging material is not limited to materials that will not substantially affect the adhesive properties of the final product when melted together. Thus, a wide variety of packaging material may be used, with materials permitting ready removal from the adhesive being preferred.

To enhance the ability to remove the adhesive from the packaging material, the packaging material may be provided with a release material. Examples of applications in which the packaging material is removed prior to post-polymerization processing include moisture-curable sealant compositions. These adhesive compositions would preferably be prepared in the form of a sealed pouch which is stripped to permit application of the sealant composition. Other examples include optically clear adhesives.

In the practice of one embodiment of the disclosure, two lengths of thermoplastic film are heat sealed together across the bottom and on each of the lateral edges on a liquid form-fill-seal machine to form an open ended pouch. The reaction mixture is pumped through a hose to fill the pouch, and the pouch is then heat scaled across the top to completely surround the adhesive composition.

Preferably, the form-fill-seal machine is equipped with an impulse sealer to form the top and bottom seal across the pouches. Such a sealer has one or two sets of jaws that clamp the pouch shut before sealing. A sealing wire is then heated to effect the seal, and the seal is cooled before the jaws are released. The sealing temperature is generally above the softening point and below the melting point of the film used to form the pouch.

During the sealing process, it is desirable to get most of the air out of the pouch before sealing. A small amount of air is tolerable so long as the amount of oxygen is not sufficient to substantially interfere with the polymerization process. For ease of handling, it is desirable to seal the pouches as soon as they are filled with the composition, although immediate sealing is not necessary in all cases. In some cases the reaction mixture can alter the packaging material, and it is desirable to cross-seal the pouches within about one minute of filling, more preferably within 30 seconds, and most preferably within 15 seconds.

If the reaction mixture decreases the strength of the packaging material, it is preferable to polymerize the composition as soon as possible after the reaction mixture is surrounded by the packaging material. For the combination of (meth)acrylate monomers with ethylene acrylic acid, ethylene vinyl acetate, or ionomer films, it is preferable to polymerize the composition within about 24 hours of sealing the pouches.

Alternatively, a single length of film can be folded lengthwise and sealed on one edge, filled with the reaction mixture, and sealed. In another embodiment, a single length of film can be pulled through a forming collar, sealed to form a tube, filled with the composition, and sealed. Another embodiment can he carried out on commercial liquid form-fill-seal machines. A source of such machines is the Packaging Machinery Division of Eagle Corp. It is contemplated that the seals can be effected in any of a number of different configurations to form multiple pouches across and down the lengths of film.

For example, in addition to the seals on the lateral edges, a seal can also he formed down the center of the lengths of film so that a cross seal will form two filled pouches. The pouches can either be left attached to each other by the cross-seals and/or vertical seals, or they can be cut into individual pouches or strands of pouches. The pouches may each contain the same or different compositions.

The reaction mixture can then be polymerized to form an adhesive composition within the polymeric pouch by any of the aforementioned methods. The adhesive composition within the polymeric pouch may be used to damp vibrations. Alternatively, the adhesive composition itself may be used to damp vibrations.

In another embodiment of the disclosure, a reaction mixture is coated onto a carrier web, covered with a sheet material, and polymerized with transmissive energy, wherein the carrier web, the sheet material, or both, are hot melt coatable with the adhesive. If both the carrier web and the sheet material are hot melt coatable, the resulting composite can be fed directly into a hot melt coater, or cut into smaller strips or pieces and fed to the hot melt coater. If only one of the carrier web or the sheet material is hot melt-coatable with the adhesive, the non-coatable entity is removed before the adhesive is hot melt coated. To facilitate handling after the non-coatable entity is removed, the polymerized adhesive can be folded over onto itself so that the coatable entity substantially surrounds the major surfaces of the coated adhesive. The adhesive web can then be fed into a hot melt coater, or it can be cut to smaller strips or pieces before hot melt coating.

If either the carrier web or the sheet material are not coatable with the adhesive (e.g., as in the case of Type II compositions, described below), it should be treated, if necessary, so that the adhesive can be removed easily from it. Such treatments include silicone release coatings, polyfluoropolyether coatings, and polyfluoroethylene coatings such as Teflon™.

The carrier web should provide sufficient strength to support the coated reaction mixture during polymerization, or it can be supported by a platen during polymerization. The carrier web can be an endless conveyor belt; or it can be a flexible material which can be wound into a roll with the adhesive; the carrier web is itself a sheet material. Endless conveyor belts can be made from silicone elastomers; polymeric films such as those made from polyfluoroethylene, polyester, nylon, polycarbonate, and the like; metals such as stainless steel; rubber; glass fibers; and the like. Useful flexible materials include paper and polymeric films such as those made from polyester, nylon, polycarbonates, polyolefins, ethylene acrylic acid, ethylene vinyl acetate, ionomers, and the like. Coatable flexible materials include polyolefins such as polypropylene, polyethylene, and polybutadiene, ethylene acrylic acid; ethylene vinyl acetate; and ionomers.

Likewise, the sheet material can be made from the aforementioned flexible materials as well as non-flexible plates made of glass, polymers, or metals, which may optionally be coated with a release material. If the reaction mixture is to be subsequently photo-polymerized, the carrier web, the sheet material, or both should be sufficiently transparent to actinic radiation to effect such photopolymerization.

Preferably, the packaging material does not substantially adversely affect the adhesive properties of a hot melt coated mixture of the packaging material and an adhesive produced from polymerization of the reaction mixture, and a hot melt coated mixture of the adhesive and the packaging material preferably has a storage modulus when measured in torsional shear at 25° C. and at 1 radian/second of between about 104 and about 108 dynes/cm².

The following examples describe some exemplary constructions of various embodiments of the adhesive articles and methods of making the adhesive articles described in the present application. The following examples describe some exemplary constructions and methods of constructing various embodiments within the scope of the present application. The following examples are intended to be illustrative, but are not intended to limit the scope of the present application.

### EXAMPLES

Examples 1-9 describe experiments wherein the thermoplastic phenolic resin is compounded with an acrylic polymer. More specifically, the material designated “Acrylic Polymer A” below is prepared by polymerizing the following monomers: 98.25 parts by weight of iso-octyl acrylate (IOA), commercially available from Sigma-Aldrich of St. Louis, Mo.; 1.75 parts by weight of acrylic acid, commercially available from Sigma-Aldrich; 0.25 parts by weight of 2,2-dimethoxy-1,2-diphenylethan-1-one photoinitiator, commercially available as IRGACURE 651 from Ciba Specialty Chemicals of Basel, CH; 0.015 parts by weight of iso-octyl thioglycolate (-mercaptoacetate) (IOTG), commercially available from Bruno Bock Chemische Fabrik GmbH of Marschacht, DE; and 0.4 parts by weight of an antioxidant, octadecyl-3-(3,5-di-tert.butyl-4-hydroxyphenyl)-propionate, commercially available as IRGANOX 1076 from Ciba Specialty Chemicals.

Acrylic polymer A was prepared in packaging materials generally as discussed in U.S. Pat. No. 5,804,610, “Methods of Making Packaged Viscoelastic Compositions,” which is hereby incorporated by reference as if rewritten. These packages of polymeric material were then placed with the ingredients as presented in Table 1 below into a compounding extruder feeding a slot extrusion die, both of conventional type. The extruder was operated at a temperature range of 300-325° F. (149-163° C.) so as to extrude a coating. The pressure and slot height parameters were set to deliver a coating weight of 37 g/m², and the coating was extruded onto a paper backing, specifically the backing used on TARTAN 5142 Utility Masking Tape, commercially available from 3M Company, St. Paul, Minn. The coated backing was then exposed to e-beam radiation at an intensity of 3.0 Mrad at 115 kV using e-beam generator commercially available from Comet Group of Kingston upon Hull, UK, forming a finished pressure sensitive adhesive on the backing.

TABLE 1

| | % by weight |
|---|---|
| Example 1 | |
| Acrylic Polymer A | 74.63% |
| Sylvalite RE 100L | 22.39% |
| Saret 519HPD | 2.24% |
| Irganox 1010 | 0.75% |
| Total | 100.00% |
| Example 2 | |
| Acrylic Polymer A | 74.63% |
| Sylvarez TP96 | 22.39% |
| Saret 519HPD | 2.24% |
| Irganox 1010 | 0.75% |
| Total | 100.00% |
| Example 3 | |
| Acrylic Polymer A | 74.63% |
| Elaztobond (E) 6000 | 22.39% |
| Saret 519HPD | 2.24% |
| Irganox 1010 | 0.75% |
| Total | 100.00% |
| Example 4 | |
| Acrylic Polymer A | 74.63% |
| SP1077 | 22.39% |
| Saret 519HPD | 2.24% |
| Irganox 1010 | 0.75% |
| Total | 100.00% |
| Example 5 | |
| Acrylic Polymer A | 74.63% |
| HRJ 4047 | 22.39% |
| Saret 519HPD | 2.24% |
| Irganox 1010 | 0.75% |
| Total | 100.00% |
| Example 6 | |
| Acrylic Polymer A | 79.37% |
| HRJ 4047 | 17.46% |
| Saret 519HPD | 2.38% |
| Irganox 1010 | 0.79% |
| Total | 100.00% |
| Example 7 | |
| Acrylic Polymer A | 86.21% |
| HRJ-4047 | 10.34% |
| Saret 519HPD | 2.59% |
| Irganox 1010 | 0.86% |
| Total | 100.00% |
| Example 8 | |
| Acrylic Polymer A | 84.03% |
| HRJ-4047 | 12.61% |
| Saret 519HPD | 2.52% |
| Irganox 1010 | 0.84% |
| Total | 100.00% |
| Example 9 | |
| Acrylic Polymer A | 84.03% |
| HRJ-2765 | 12.61% |
| Saret 519HPD | 2.52% |
| Irganox 1010 | 0.84% |
| Total | 100.00% |
| Comparative Ex. C-1 | |
| Acrylic Polymer A | 96.14% |
| Saret 519HPD | 2.89% |
| Irganox 1010 | 0.97% |
| Total | 100.00% |

Comparative Example C-1 resembles Example 5, except that the octyl-phenolic resin has been left out to determine the impact of its presence compared to Examples 5-7.

The other ingredients mentioned in this table are:

ELAZTOBOND T6000—modified phenol formaldehyde resin, commercially available from SI Group, Inc. of Schenectady, N.Y.

SP1077—modified octyl-phenolic resin with a softening point of 92 to 101° C., commercially available from SI Group, Inc.

HRJ 4047—Octyl-phenolic Resin (SP 92-101° C.), commercially available from SI Group, Inc.

HRJ-2765—Octyl-phenolic Resin (SP 90-100° C.), commercially available from SI Group, Inc.

SYLVALITE RE 100L—rosin ester tackifier (SP 96-102° C.), commercially available for Arizona Chemical of Jacksonville, Fla.

SYLVAREZ TP 96—low softening point terpene phenolic resin, commercially available from Arizona Chemical.

SARET 519HPD—acrylic cross-linking co-agent, commercially available from Sartomer of Exton, Pa.

IRGANOX 1010—primary phenolic antioxidant stabilizer, commercially available from BASF of Ludwigshafen, DE.

An experiment was performed to determine the effect of the inclusion of octyl-phenolic resin in the compositions. More particularly, Comparative Example C-1 was compared with Examples 5, 6 and 7 when adhered to several surfaces and conditions. These results are shown in Table 2.

TABLE 2

| | Adhesion to diverse adherends and conditions, (oz/in) | | | | |
|---|---|---|---|---|---|
| | | | | PROMAR | PROMAR |
| | | | PROMAR | paint at | paint at 79° F. |
| | | Poly- | paint at room | 79° F. and | and 74% RH |
| Example | Glass | propylene | temperature | 74% RH | (aged_hrs.) |
| C-1 | 29.3 | 15.0 | 8.0 | 1.2 | 0.0 |
| 5 | 50.5 | 36.5 | 29.1 | 27.5 | 27.2 |
| 6 | 53.1 | 34.9 | 30.4 | 20.7 | 30.3 |
| 7 | 36.6 | 27.3 | 17.8 | 12.0 | 18.7 |

PROMAR refers to PROMAR 200 Zero VOC interior paint commercially available from Sherwin-Williams of Cleveland, OH.

This experiment shows that the addition of the octyl-phenolic resin greatly increased the adhesion of the tested tapes to difficult adherends, even in the face of elevated temperature and humidity.

Examples 10-17 describe experiments wherein the thermoplastic phenolic resin is compounded with a natural rubber. More specifically, natural rubber, commercially available as CV60 from RCMA Commodities Group of the United States was masticated for 6 minutes at 150° C. and at 60 r.p.m. in a thermostatically controlled Brabender cam masticator commercially available from Brabender of Duisburg, DE.

The masticated rubber was then placed with the ingredients as presented in Table 3 below into a compounding extruder feeding a slot extrusion die, both of conventional type. The extruder was operated at a temperature range of 350-375° F. (177-191° C.) so as to extrude a coating. The pressure and slot height parameters were set to deliver a coating weight of 37 g/m², and the coating was extruded onto a paper backing, specifically the paper backing used on 388N Tape, commercially available from 3M Company, of St. Paul, Minn. The coated backing was then exposed to e-beam radiation at an intensity of 3.0 Mrad at 115 kV using e-beam generator commercially available from Comet Group of Kingston upon Hull, UK, forming a finished pressure sensitive adhesive on the backing.

TABLE 3

| | % by weight |
|---|---|
| Example 10 | |
| Natural rubber | 38.46% |
| Kraton D1340 | 16.48% |
| Escorez 1304 | 0.00% |
| Elaztobond T6000 | 43.96% |
| Irganox 1010 | 1.10% |
| Total | 100.00% |
| Example 11 | |
| Natural rubber | 38.46% |
| Kraton D1340 | 16.48% |
| Escorez 1304 | 21.98% |
| Elaztobond T6000 | 21.98% |
| Irganox 1010 | 1.10% |
| Total | 100.00% |
| Example 12 | |
| Natural rubber | 38.46% |
| Kraton D1340 | 16.48% |
| Escorez 1304 | 0.00% |
| SP-1077 | 43.96% |
| Irganox 1010 | 1.10% |
| Total | 100.00% |
| Example 13 | |
| Natural rubber | 38.46% |
| Kraton D1340 | 16.48% |
| Escorez 1304 | 21.98% |
| SP1077 | 21.98% |
| Irganox 1010 | 1.10% |
| Total | 100.00% |
| Example 14 | |
| Natural rubber | 38.46% |
| Kraton D1340 | 16.48% |
| Escorez 1304 | 0.00% |
| HRJ4047 | 43.96% |
| Irganox 1010 | 1.10% |
| Total | 100.00% |
| Example 15 | |
| Natural rubber | 38.46% |
| Kraton D1340 | 16.48% |
| Escorez 1304 or | 21.98% |
| Qunitone K100 | |
| HRJ4047 | 21.98% |
| Irganox 1010 | 1.10% |
| Total | 100.00% |
| Example 16 | |
| Natural rubber | 38.46% |
| Kraton D1340 | 16.48% |
| Qunitone K100 | 32.97% |
| HRJ4047 | 10.99% |
| Irganox 1010 | 1.10% |
| Total | 100.00% |
| Example 17 | |
| Natural rubber | 38.46% |
| Kraton D1340 | 16.48% |
| Qunitone K100 | 43.96% |
| Irganox 1010 | 1.10% |
| Total | 100.00% |

The other ingredients mentioned in this table for the first time are:

Kraton D1340—a SBS block copolymer commercially available from Arizona Chemical.

Escorez 1304—a tackifying resin commercially available from Exxon Mobil of Irving, Tex.

Qunitone K100—an aliphatic hydrocarbon resin commercially available from Zeon Chemicals of Louisville, Ky.

An experiment was performed to determine the effect of the inclusion of octyl-phenolic resin in natural rubber compositions, and also to learn the effect of a blend of the octyl-phenolic resins with other, more conventional aliphatic tackifying resins. More particularly, Comparative Example C-2 was compared with Examples 11, 13, 14, and 15 when adhered to several surfaces and conditions. Comparative Example C-2 is a commercially available masking tape, specifically SCOTCH General Purpose Masking Tape 2020, from 3M Company. These results are shown in Table 4.

TABLE 4

| | Adhesion to diverse adherends and conditions, (oz/in) | | | |
|---|---|---|---|---|
| | | | PROMAR | PROMAR |
| | | | paint at room | paint at 79° F. |
| Example | Glass | Polypropylene | temperature | and 74% RH |
| C-2 | 46.0 | 32.0 | 22.0 | 7.0 |
| Example 11 | 49.1 | 36.9 | 24.5 | 27.4 |
| Example 13 | 36.7 | 24.5 | 16.2 | 18.8 |
| Example 14 | 30.2 | 25.8 | 18.3 | 17.5 |
| Example 15 | 39.7 | 27.2 | 25.1 | 27.0 |

PROMAR refers to PROMAR 200 Zero VOC interior paint commercially available from Sherwin-Williams.

This experiment shows that the addition of some portion of aliphatic tackifier, e.g. C5 resins, may synergize with phenolic resins to further increase the adhesion of the tested tapes to difficult adherends, even in the face of elevated temperature and humidity.

Examples 18 and 19 describe experiments wherein the thermoplastic phenolic resin is compounded with synthetic rubbers, specifically poly(styrene-butadiene-styrene) (SBS) and poly(styrene-isoprene-styrene) (SIS) block copolymers.

The synthetic rubbers were placed with the ingredients as presented in Table 5 below into a compounding extruder feeding a slot extrusion die, both of conventional type. The extruder was operated at a temperature range of 350-375° F. (177-191° C.) so as to extrude a coating. The pressure and slot height parameters were set to deliver a coating weight of 37 g/m², and the coating was extruded onto a paper backing, specifically the paper backing used on TARTAN 5142 Utility Masking Tape, commercially available from 3M Company. The coated backing was then exposed to e-beam radiation at an intensity of 3.0 Mrad at 115 kV using e-beam generator commercially available from Comet Group, forming a finished pressure sensitive adhesive on the backing.

TABLE 5

| | % by weight |
|---|---|
| Example 18 | |
| Kraton D1102 (SBS) | 58.31% |
| HRJ-4047 | 11.66% |
| Wingtack 86 | 29.15% |
| Irganox 1726 | 0.87% |
| Total | 100.00% |
| Example 19 | |
| Kraton D1161 (SIS) | 58.31% |
| HRJ-4047 | 11.66% |
| Escorez 2203 | 29.15% |
| Irganox 1010 | 0.87% |
| Total | 100.00% |

The other ingredients mentioned in this table for the first time are:

Kraton D1102 (SBS)—a clear, linear triblock copolymer based on styrene and butadiene, with a polystyrene content of 28%, commercially available from Kraton Performance Polymers of Houston, Tex.

Kraton D1161 (SIS)—a clear, linear triblock copolymer based on styrene and isoprene, with a polystyrene content of 15%, commercially available from Kraton Performance Polymers.

Wingtack 86—an aromatically modified C-5 hydrocarbon resin, commercially available from Cray Valley USA, of Exton, Pa.

Irganox 1726—a multifunctional phenolic antioxidant containing 4,6-bis (dodecylthiomethyl)-o-cresol, commercially available from BASF.

Escorez 2203—an aliphatic and aromatic hydrocarbon, commercially available from Exxon Mobil.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

All references mentioned herein are hereby incorporated by reference in their entirety.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

What is claimed is:

1. A pressure sensitive adhesive composition, comprising:
a thermoplastic phenolic resin made from the reaction of
(1) alkyl phenol (e.g., butyl- or octyl- or -nonyl) and formaldehyde; or
(2) alkyl phenol (e.g., butyl- or octyl-) and acetaldehyde; or
(3) alkyl phenol (e.g., butyl- or octyl-) and acetylene.

2. The pressure sensitive adhesive composition of claim 1, further comprising:
at least one of an acrylic, a rubber, a natural rubber, an isoprene block copolymer, a butadiene block copolymer, and combinations thereof.

3. The pressure sensitive adhesive composition of claim 2, wherein the isoprene block copolymer is styrene-isoprene-styrene block copolymer.

4. The pressure sensitive adhesive composition of claim 2, wherein the butadiene block copolymer is styrene-butadiene-styrene block copolymer.

5. The pressure sensitive adhesive composition of claim 1, further comprising:
a tackifier selected from a list consisting essentially of polyterpene, rosin esters, terpene phenol, a hydrocarbon resin, and combinations thereof.

6. The pressure sensitive adhesive composition of claim 1, wherein the thermoplastic phenolic resin is present in an amount of between about 2 wt % and about 45 wt %.

7. The pressure sensitive adhesive composition of claim 1, wherein the alkyl phenol has been modified with a functional group selected from a list consisting essentially of epoxy, rosin, terpene, butadiene, and combinations thereof.

8. An adhesive article, comprising:
a backing; and
the pressure sensitive adhesive composition of claim 1.

9. The adhesive article of claim 9, wherein the backing is paper or plastic.

10. The adhesive article of claim 8, wherein the adhesive article exhibits improved adhesion to an adherend including an architectural coating having at least one of low or no VOCs, a deep base formulation, or a formulation including primer as compared to an adhesive article not including the thermoplastic phenolic resin.

11. The adhesive article of claim 8, wherein the adhesive article exhibits improved adhesion to an adherend including an architectural coating having at least one of low or no VOCs, a deep base formulation, or a formulation including primer as compared to an adhesive article not including the thermoplastic phenolic resin when measured at 79° F. and 74% relative humidity.

12. The adhesive article of claim 10, wherein the adherend is at least one of painted drywall, glass, stainless steel, plastic, or combinations thereof.

13. The pressure sensitive adhesive composition of claim 1, wherein the thermoplastic phenolic resin is made from the reaction of alkyl phenol and formaldehyde.

14. The pressure sensitive adhesive composition of claim 1, wherein the thermoplastic phenolic resin is made from the reaction of alkyl phenol and acetaldehyde.

15. The pressure sensitive adhesive composition of claim 1, wherein the thermoplastic phenolic resin is made from the reaction of alkyl phenol and acetylene.

16. The pressure sensitive adhesive composition of claim 13, wherein the alkyl phenol has been modified with a functional group selected from a list consisting essentially of epoxy, rosin, terpene, butadiene, and combinations thereof.

17. The pressure sensitive adhesive composition of claim 14, wherein the alkyl phenol has been modified with a functional group selected from a list consisting essentially of epoxy, rosin, terpene, butadiene, and combinations thereof.

18. The pressure sensitive adhesive composition of claim 15, wherein the alkyl phenol has been modified with a functional group selected from a list consisting essentially of epoxy, rosin, terpene, butadiene, and combinations thereof.

19. The pressure sensitive adhesive composition of claim 13, further comprising: a tackifier selected from a list consisting essentially of polyterpene, rosin esters, terpene phenol, a hydrocarbon resin, and combinations thereof, wherein the thermoplastic phenolic resin is present in an amount of between about 2 wt % and about 45 wt %.
